(19) United States
(12) Patent Application Publication
(10) Pub. No.: US 2008/0198937 A1
(43) Pub. Date: Aug. 21, 2008

(54) Video Processing Data Provisioning

(76) Inventor: Samir N. Hulyalkar, Newtown, PA (US)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(21) Appl. No.: 11/874,659

(22) Filed: Oct. 18, 2007

Related U.S. Application Data
(60) Provisional application No. 60/829,893, filed on Oct. 18, 2006.

(51) Int. Cl. H04N 5/14; H04N 7/26

(52) U.S. Cl. 375/240.28; 348/571; 348/659; 375/E07.187; 348/E05.062

(57) ABSTRACT

A method and system for performing response-time compensation on video pixel data includes an output coupled to a timing controller for, the timing controller providing response time pixel data to a video display screen or panel. The system including a video signal processing module to determine pixel data indicative of how to excite respective video pixels in a video frame. The system including an interface for outputting substantially concurrently, the current-frame pixel data relating to a pixel at a particular location in the current video frame and prior-frame pixel data relating to the pixel at the particular location in the prior video frame relative to the current video frame. The current-frame pixel data and the prior-frame pixel data can be interlaced in the output signal. The prior-frame pixel data can be compressed in the output signal. The output can include multiple channels and the current-frame pixel data and the prior-frame pixel data can be output over separate channels.

### CROSS-REFERENCE TO RELATED APPLICATIONS

This application claims any and all benefits as provided by law of U.S. Provisional Application No. 60/829,893 filed Oct. 18, 2006 which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

The use of video information, which can contain corresponding audio information, is already a tremendously widespread source of information and is more widespread every day. Not only is more video information used/conveyed, but the information is more complex, with more information contained in video transmissions. Along with the increase in content is a desire for faster processing of the video information, and reduced cost to process the information.

Existing digital television receivers use multiple integrated circuit chips to process video information. For example, one chip may be used to provide back-end processing such as video decoding, audio processing, deinterlacing, scaling, etc. while another chip is used to provide response-time compensation (RTC), which improves the response-time of the LCD crystals on LCD panels. These chips may be on different boards, e.g., with the back-end processing chip being on a television motherboard and the RTC chip on a timing control board of a display panel. The back-end processing chip and the RTC chip use separate memories, occupying separate space and using separate memory calls. The RTC memory stores a frame of pixel information for use in performing RTC using the previous, stored pixels and incoming current pixels. Advanced forms of RTC can use more than one previous frames.

### SUMMARY

In general, in an aspect, the invention provides a system for performing response-time compensation on video pixel data, the system including an output configured to be coupled to a timing controller, at least one video signal processing module configured to process information relating to pixels in a video frame to determine pixel data indicative of how to excite respective pixels in the video frame, and an interface coupled to at least one of the at least one video signal processing module and to the output and configured to provide current-frame pixel data and prior-frame pixel data to the output substantially concurrently, the current-frame pixel data relating to a pixel at a particular location in a current video frame and the prior-frame pixel data relating to the pixel at the particular location in a prior video frame relative to the current video frame.

Implementations of the invention can include one or more of the following features. The prior-frame pixel data correspond to a video frame immediately preceding the current frame. The output is a dual low-voltage differential signaling connector and the interface is configured to provide the current-frame pixel data on a first connection of the output and to provide the prior-frame pixel data on a second connection of the output. The interface is configured to interlace the current-frame pixel data and the prior-frame pixel data and to provide the interlaced data to the output at approximately twice a rate at which the timing controller can process data for a single video frame pixel. The system further includes a data compressor coupled to at least one of the at least one video processing module and to the interface, the interface being coupled to at least one of the at least one video processing module through the data compressor, wherein the data compressor is configured to compress the prior-frame pixel data to provide compressed prior-frame pixel data that comprise X % of a size of the prior-frame pixel data before compression, and wherein the interface is configured to interlace the compressed prior-frame pixel data and the current-frame pixel data and to provide the interlaced data to the output at approximately (100+X) % of a rate at which the timing controller can process data for a single video frame pixel.

In general, in another aspect, the invention provides a method of processing video signals in a receiver, the method including receiving incoming video signals, processing the video signals into frames of pixel data indicative of pixel excitations for pixels in video frames for display, and sending current-frame pixel data and prior-frame pixel data toward a timing controller substantially concurrently, the current-frame pixel data indicative of a first excitation of a pixel at a particular location in a current video frame and the prior-frame pixel data indicative of a second excitation of the pixel at the particular location in a prior video frame relative to the current video frame.

Implementations of the invention can include one or more of the following features. The prior-frame pixel data correspond to a video frame immediately preceding the current frame. The sending includes sending the current-frame pixel data on a first connection of a low-voltage differential signaling connection and sending the prior-frame pixel data on a second connection of the low-voltage differential signaling connection. The method further includes interlacing the current-frame pixel data and the prior-frame pixel data, wherein the sending comprises sending the interlaced data toward the timing controller at approximately twice a rate at which the timing controller can process data for a single video frame pixel. The method further includes compressing the prior-frame pixel data to provide compressed prior-frame pixel data that comprise X % of a size of the prior-frame pixel data before compression, and interlacing the current-frame pixel data and the compressed prior-frame pixel data, where the sending includes sending the interlaced data toward the timing controller at approximately (100+X) % of a rate at which the timing controller can process data for a single video frame pixel.

Various aspects of the invention can provide one or more of the following capabilities. Board space for video processing can be reduced. Cost for video processing circuitry can be reduced. Redundant storage of video processing information can be reduced. A unified memory architecture, with less memory than prior arrangements, can be achieved while using separate back-end processing and timing compensation chips. Cost of an interface between a back-end processor module and a timing compensation unit can be reduced compared to current techniques.

These and other capabilities of the invention, along with the invention itself, will be more fully understood after a review of the following figures, detailed description, and claims.

### BRIEF DESCRIPTION OF THE FIGURES

FIG. 1 is a block diagram of a video system including a transmitter and a receiver.

FIG. 2 is a block diagram of a back-end processor and a timing controller, including a response-time compensation chip, of the receiver shown in FIG. 1.

FIG. 3 is a block flow diagram of processing video signals using the system shown in FIG. 1.

FIGS. 4-5 are block diagrams of back-end processors and timing controllers.

### DETAILED DESCRIPTION OF PREFERRED EMBODIMENTS

Embodiments of the invention provide techniques for processing video information. For example, a television motherboard can provide previous-frame pixels and current pixels to a response-time compensation (RTC) module substantially concurrently and the RTC module can perform response-time compensation without using previous-frame pixels stored by the RTC module. For example, the previous-frame and current pixels can be provided to the RTC module via a dual-LVDS (low voltage differential signal) connector, at a higher than normal LVDS clock rate, or at a higher than normal LVDS clock using a compressed version of some of the pixels, e.g., the previous-frame pixels. Other embodiments are within the scope of the invention.

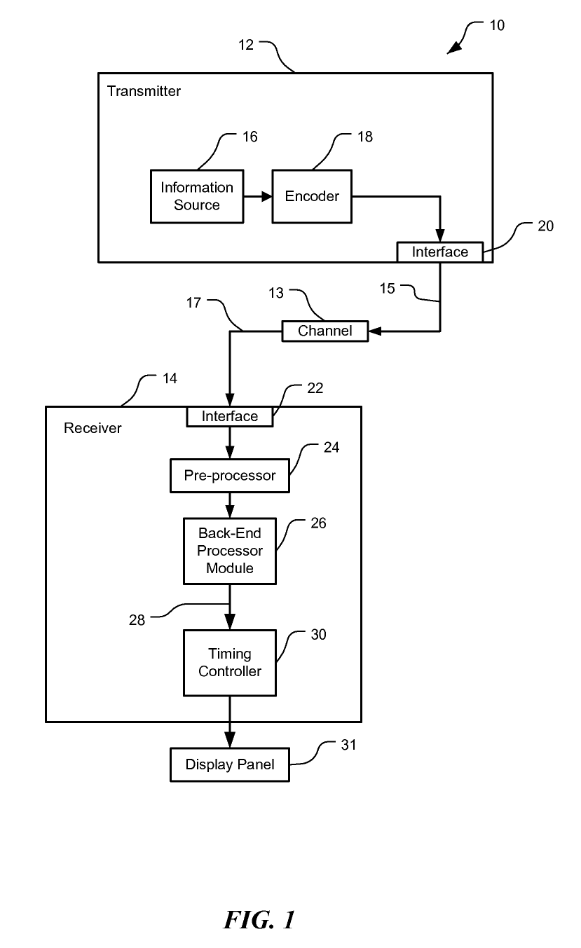

Referring to FIG. 1, a communication system 10 comprises a transmitter 12 and a receiver 14. The system 10 includes appropriate hardware, firmware, and/or software (including computer-readable, preferably computer-executable instructions) to implement the functions described below. The transmitter 12 can be, e.g., a terrestrial or cable information provider such as a cable television provider, and the receiver 14 is a corresponding device (e.g., a digital television such as a high-definition television, or a set-top box and television combination) for receiving the transmitted information. The transmitter 12 and the receiver 14 are linked by a transmission channel 13. The transmission channel 13 is a signal propagation medium such as a cable or the atmosphere.

The transmitter 12 includes an information source 16, an encoder 18, and an interface 20. The information source 16 provides information such as television signals, video, audio, or data (e.g., Internet communications). The encoder 18 is connected to the source 16 and the interface 20 and is configured to encode information from the source. The encoder can be any, or a combination, of a variety of encoders such as an OFDM encoder, an analog encoder, a digital encoder such as an MPEG2 video encoder or an H.264 encoder, etc. The encoder 18 is configured to provide the encoded information to the interface 20. The interface 20 can be an antenna for terrestrial transmitters, or cable interface for a cable transmitter, etc.

The receiver 14 is configured to receive information from the transmitter 12 and process the received information to provide the information in a desired format, e.g., as video, audio, data. The receiver 14 includes an interface 22, a pre-processor 24, and a back-end processor module 26. The pre-processor 24 includes appropriate apparatus to prepare incoming signals for the module 26. For example, the pre-processor 24 can include a tuner (e.g., for satellite, terrestrial, or cable television), an HDMI interface, a DVI connector, etc.

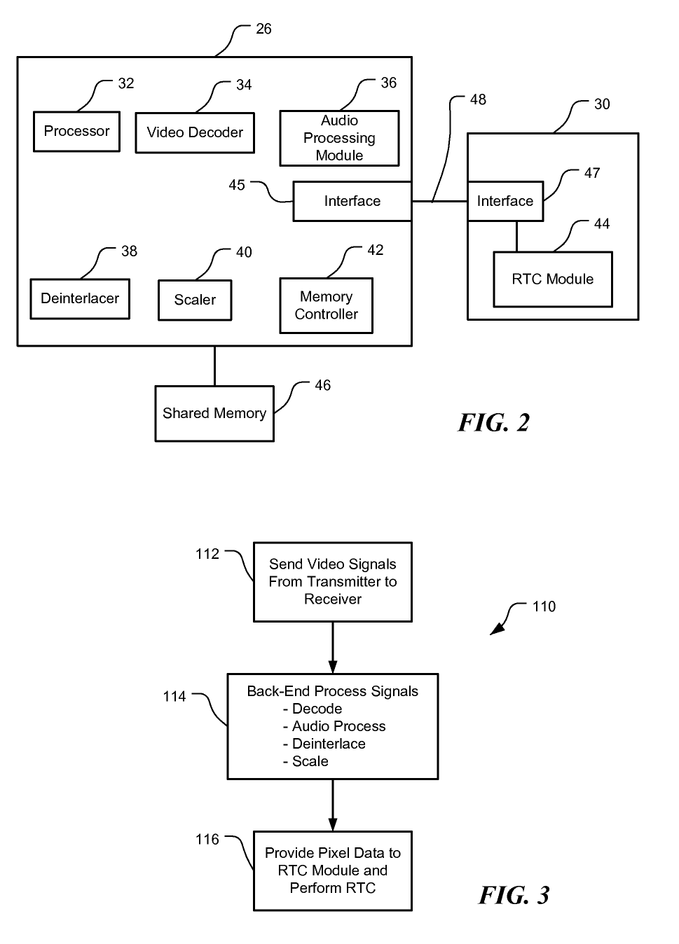

The module 26 is configured to process the information from the pre-processor 24 to recover original information encoded by the transmitter 12 prior to transmission, and to render the information in an appropriate format as a signal 28 for further processing by a timing controller 30 and display by a display screen or panel 31. The module 26 provides pixel data to the controller 30 with the pixel data indicating how to excite respective pixels in a video frame. Referring also to FIG. 2, the back-end processing module 26 includes a processor 32, a video decoder 34, an audio processing module 36, a deinterlacer 38, a scaler 40, a memory controller 42, and an interface 43 and the timing controller 30 includes an interface 45 and an RTC module 44. The module 26 and the controller 30 are preferably, though not necessarily, disposed on a common circuit board. The processor 32 and the memory controller 42 are directly connected to each of the components 34, 36, 38, 40. The decoder 34 is an appropriate decoder for the corresponding encoder 18, e.g., an OFDM decoder, an analog decoder, a digital decoder such as an MPEG2 video decoder or an H.264 decoder, etc. The module 26 is connected to a single, shared memory 46 that is used for each of the processor 32, the video decoder 34, the audio processing module 36, the deinterlacer 38, and the scaler 40.

Dual-LVDS Connections

The module 26 is configured to produce pixel data and provide the pixel data to the timing controller 30 via a dual LVDS connection 48. The dual LVDS connection 48 provides multiple connections such that data for multiple pixels can be provided by the module 26 to the timing controller 30 concurrently. The module 26 is configured to provide pixel data for multiple, preferably consecutive, image frames on respective, different connections of the dual LVDS connection 48, preferably concurrently. The interface 45 directs the pixel data of the current frame and the prior frame to the appropriate connections of the dual connection 48. The timing controller 30, and in particular the RTC module 44, is configured to use the pixel data from consecutive frames of pixels to perform response-time compensation. The interface 47 can separate the pixel data from the different connections in the dual connection 48 and provide the pixel data to the RTC module 44 to process the separated pixel data accordingly. The timing controller 30 can use the pixel data from the different connections within the dual LVDS connection 48 to perform response-time compensation without storing the pixel data from a previous frame for use with pixel data from a current frame. The timing controller 30 is configured to analyze a current pixel and a previous pixel (i.e., the pixel in a preceding frame corresponding to the current pixel's location in the frame) and to search a lookup table to determine a modification to the current pixel and to modify the current pixel accordingly for display.

The interfaces 45, 47 can be separate components, or can be portions of other components shown. For example, the interface 45 can be a part of the last component 34, 36, 38, 40 to process pixel data before the pixel data are ready for transfer to the controller 30. Alternatively, the interface 45 can include its own processor, or can be controlled by the processor 32. Further, the interface 47 can be included as part of the RTC module 44 or other component in the timing controller 30.

In operation, referring to FIG. 3, with further reference to FIGS. 1-2, a process 110 for processing video signals using the system 10 includes the stages shown. The process 110, however, is exemplary only and not limiting. The process 110 can be altered, e.g., by having stages added, removed, or rearranged.

At stage 112, video signals are sent from the transmitter 12 to the receiver 14 and pre-processed. The source 16 supplies signals that are encoded by the encoder 18, transmitted via the interfaces 20, 22 and the channel 13 to the pre-processor 24. The pre-processor 24 appropriately prepares the signals (e.g., tunes) for the back-end processor module 26.

At stage 114, the back-end processing module 26 decodes, audio processes, deinterlaces, and scales the incoming signals. The memory controller 42 manages read and write access to the memory 46 by the components 34, 36, 38, 40 of the module 26. The memory controller 42 interleaves access by the components 34, 36, 38, 40 according to priorities. The components 34, 36, 38, 40 can use shared algorithms as appropriate and access and process intermediate data stored in the memory 46 by other components 34, 36, 38, 40 as appropriate.

At stage 116, the module 26 provides pixel data to the RTC module 44 which performs response-time compensation on the pixel data. The module 26 provides pixel data for a current frame over one connection of the dual LVDS connection 48 and pixel data for an immediately-previous frame over the other connection of the dual LVDS connection 48. The RTC module 44 receives the pixel data, separates the pixel data from the respective connections of the dual LVDS connection 48, searches a lookup table to determine modification to the current pixel, and modifies the current pixel accordingly for display.

Other embodiments are within the scope and spirit of the appended claims. For example, due to the nature of software, functions described above can be implemented using software, hardware, firmware, hardwiring, or combinations of any of these. Features implementing functions can also be physically located at various positions, including being distributed such that portions of functions are implemented at different physical locations.

High Clock Rate Pixel Data

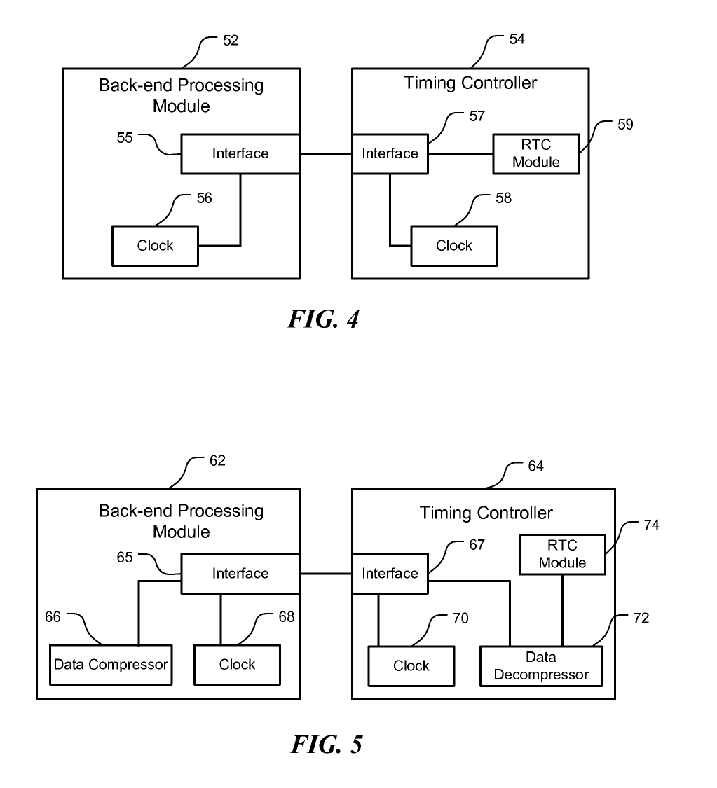

Referring to FIG. 4, a back-end processing module 52 is connected to a timing controller 54. The module 52 includes a clock 56 and the controller 54 includes a clock 58. The clocks 56, 58 are configured to control a rate of transfer of pixel data between the module 52 and the controller 54. The clocks 56, 58 are configured such that the module 52 can provide pixel data to the timing controller 54, and the timing controller 54 can receive and separate pixel data, at about twice the data rate to provide the transfer using a single LVDS connection. This can be accomplished, for example, with the back-end processor module 26 and the timing controller 30 on a single board or with an interface between the module 26 and the controller 30 configured to run at double the data rate. The pixel data can be transferred from the module 52 to the controller 54 at about twice the rate at which the controller 54 can process a single current pixel for display. The module 52 and the controller 54 are preferably, though not necessarily, disposed on a common circuit board.

The module 52 is configured to provide pixel data for a current frame interlaced with pixel data for an immediately prior frame. An interface 55 is connected and configured to receive and interlace prior-frame pixel data and current-frame pixel data and to transfer the interlaced data to the controller 54. Thus, the pixel data for a particular location in the current frame and the pixel data for the pixel of the same location in the immediately-prior frame are transferred consecutively from the module 52 to the controller 54. The pixel data of the current frame can precede the pixel data of the prior frame, or vice versa. Preferably, the order is predetermined and consistent and the controller 54 is configured to process the data for the pixels assuming the predetermined order. Alternatively, the pixel data can include an indication of whether the data are for the current frame or the prior frame. An interface 57 is connected and configured to deinterlace the pixel data and to provide the prior-frame pixel data and the current-frame pixel data to an RTC module 59 for response-time compensation.

In operation, the module 52 sends interlaced pixel data to the controller 54 at a higher rate than for non-interlaced operation, e.g., about twice the single pixel processing rate of the controller 30 (FIG. 2). The controller 54 separates the interlaced pixel data and performs response-time compensation.

Pixel Data Compression

Referring to FIG. 5, a back-end processing module 62 is connected to a timing controller 64. The module 62 and the controller 64 can be disposed on separate circuit boards or on a common circuit board. The module 62 is configured to provide pixel data for a current frame interlaced with pixel data for an immediately prior frame. An interface 65 is connected and configured to receive and interlace prior-frame pixel data and current-frame pixel data and to transfer the interlaced data to the controller 64. Thus, the pixel data for a particular location in the current frame and the pixel data for the pixel of the same location in the immediately-prior frame are transferred consecutively from the module 62 to the controller 64. The pixel data of the current frame can precede the pixel data of the prior frame, or vice versa. Preferably, the order is predetermined and consistent and the controller 64 is configured to process the data for the pixels assuming the predetermined order. Alternatively, the pixel data can include an indication of whether the data are for the current frame or the prior frame. An interface 67 is connected and configured to deinterlace the pixel data and to provide the prior-frame pixel data and the current-frame pixel data to a data decompressor 72.

The module 62 includes a data compressor 66 and a clock 68 and the controller 64 includes a clock 70 and the data decompressor 72. The data compressor 66 preferably comprises hardware and is configured to compress pixel data, preferably from a prior frame, e.g., to compress the data by a 4:1 ratio. The clocks 68, 70 are configured to control a rate of transfer of pixel data between the module 62 and the controller 64. The clocks 68, 70 are configured such that the module 62 can provide pixel data to the timing controller 64, and the timing controller 64 can receive and separate pixel data, at a higher rate than is typical (e.g., higher than the pixel data rate of either connection of the dual connection 48 in FIG. 2, and/or higher than a rate at which the controller is configured to perform per-pixel response-time compensation). Preferably, the clocks 68, 70 operate at a frequency as a function of the compression rate provided by the data compressor 66. Preferably, the clocks 68, 70 operate to cause the interfaces 65, 67 to transfer pixel data at (100+X) % of the rate at which the controller 64 can process a single pixel of data, where X % is the percent of size (e.g., bits) occupied by the compressed data compared to the uncompressed data. For example, if the data compressor 66 provides about 4:1 compression, the pixel data is about 25% as large after compression compared to before compression, and the clocks 68, 70 preferably operate at about 125% of the rate that the controller 64 can process a single current pixel for display. The controller 64 is configured to separate the interlaced data and provide the compressed data to the data decompressor 72. The data decompressor 72 is configured to decompress the compressed prior-frame pixel data and to provide the decompressed data to an RTC module 74 to process the current-frame pixel data and the decompressed prior-frame pixel data to perform response-time compensation.

In operation, the module 62 compresses pixel data for a prior frame and sends the compressed pixel data and uncompressed current pixel data interlaced to the controller 64 at a higher rate than for non-interlaced operation, e.g., in accordance with the compression rate provided by the data compressor 66. The controller 64 separates the interlaced pixel data, decompresses the compressed data, and performs response-time compensation on the pixel data.

In addition to hardware implementations of devices that are for performing response-time compensation on pixel data in accordance with an embodiment of the present invention such devices may also be embodied in software disposed, for example, in a computer usable (e.g., readable) medium configured to store the software (e.g., a computer readable program code). The program code causes the enablement of embodiments of the present invention, including the following embodiments: (i) the functions of the systems and methods disclosed herein (such as systems and methods for performing response-time compensation on pixel data); (ii) the fabrication of the systems and methods disclosed herein (such as the fabrication of devices that are enabled to perform response-time compensation on pixel data); or (iii) a combination of the functions and fabrication of the systems and methods disclosed herein.

For example, this can be accomplished through the use of general programming languages (such as C or C++), hardware description languages (HDL) including Verilog, Verilog-A, HDL, VHDL, Altera HDL (AHDL) and so on, or other available programming and/or schematic capture tools (such as circuit capture tools). The program code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and internets. It is understood that the functions accomplished and/or structure provided by the systems and techniques described above can be represented in a core (such as a media processing core) that is embodied in program code and may be transformed to hardware as part of the production of integrated circuits.

Still other embodiments are within the scope of the invention.

Further, while the description above refers to “the invention,” more than one invention can be disclosed.

What is claimed is:

1. A system for performing response-time compensation on video pixel data, the system comprising:
an output configured to be coupled to a timing controller;
at least one video signal processing module configured to process information relating to pixels in a video frame; and
an interface coupled to at least one of the at least one video signal processing module and to the output and configured to provide current-frame pixel data and prior-frame pixel data to the output substantially concurrently, the current-frame pixel data relating to a pixel at a particular location in a current video frame and the prior-frame pixel data relating to the pixel at the particular location in a prior video frame relative to the current video frame.

2. The system of claim 1 wherein the prior-frame pixel data correspond to a video frame immediately preceding the current frame.

3. The system of claim 1 wherein the output is a dual low-voltage differential signaling output and the interface is configured to provide the current-frame pixel data on a first connection of the output and to provide the prior-frame pixel data on a second connection of the output.

4. The system of claim 1 wherein the interface is configured to interlace the current-frame pixel data and the prior-frame pixel data and to provide the interlaced data to the output at approximately twice a rate at which the timing controller can process data for a single video frame pixel.

5. The system of claim 1 further comprising a data compressor coupled to at least one of the at least one video processing module and to the interface, the interface being coupled to at least one of the at least one video processing module through the data compressor, wherein the data compressor is configured to compress the prior-frame pixel data to provide compressed prior-frame pixel data that comprise X % of a size of the prior-frame pixel data before compression, and wherein the interface is configured to interlace the compressed prior-frame pixel data and the current-frame pixel data and to provide the interlaced data to the output at approximately (100+X) % of a rate at which the timing controller can process data for a single video frame pixel.

6. The system of claim 1 comprising computer readable media storing instructions in a hardware description language software.

7. The system of claim 6, wherein the instructions comprise at least one of: Verilog hardware description language software, Verilog-A hardware description language software, and VHDL hardware description language software.

8. A method of processing video signals in a receiver, the method comprising:
receiving incoming video signals;
processing the video signals into frames of pixel data; and
sending current-frame pixel data and prior-frame pixel data toward a timing controller substantially concurrently, the current-frame pixel data indicative of a first excitation of a pixel at a particular location in a current video frame and the prior-frame pixel data indicative of a second excitation of the pixel at the particular location in a prior video frame relative to the current video frame.

9. The method of claim 8 wherein the prior-frame pixel data correspond to a video frame immediately preceding the current frame.

10. The method of claim 8 wherein the sending comprises sending the current-frame pixel data on a first connection of a low-voltage differential signaling connection and sending the prior-frame pixel data on a second connection of the low-voltage differential signaling connection.

11. The method of claim 8 further comprising interlacing the current-frame pixel data and the prior-frame pixel data, wherein the sending comprises sending the interlaced data toward the timing controller at approximately twice a rate at which the timing controller can process data for a single video frame pixel.

12. The method of claim 8 further comprising:
compressing the prior-frame pixel data to provide compressed prior-frame pixel data that comprise X % of a size of the prior-frame pixel data before compression; and
interlacing the current-frame pixel data and the compressed prior-frame pixel data;
wherein the sending comprises sending the interlaced data toward the timing controller at approximately (100+X) % of a rate at which the timing controller can process data for a single video frame pixel.

13. A computer readable media storing instructions, said instructions when executed are adapted to:
receive incoming video signals;
process the video signals into frames of pixel data; and
send current-frame pixel data and prior-frame pixel data toward a timing controller substantially concurrently, the current-frame pixel data indicative of a first excitation of a pixel at a particular location in a current video frame and the prior-frame pixel data indicative of a second excitation of the pixel at the particular location in a prior video frame relative to the current video frame.

14. The system of claim 13 wherein said instructions comprise instructions in a hardware description language software.

15. The system of claim 14, wherein the instructions in a hardware description language comprise at least one of: Verilog hardware description language software, Verilog-A hardware description language software, and VHDL hardware description language software.
